(19) United States
(12) Patent Application Publication
(10) Pub. No.: US 2021/0316386 A1
(43) Pub. Date: Oct. 14, 2021

(54) ARC WELDING METHOD

(71) Applicant: Kabushiki Kaisha Kobe Seiko Sho (Kobe Steel, Ltd.), Kobe-Shi (JP)

(72) Inventors: Hikaru Kinashi, Fujisawa-shi (JP); Yu Umehara, Fujisawa-shi (JP); Koji Sato, Fujisawa-shi (JP)

(73) Assignee: Kabushiki Kaisha Kobe Seiko Sho (Kobe Steel, Ltd.), Kobe-shi (JP)

(21) Appl. No.: 17/358,492

(22) Filed: Jun. 25, 2021

Related U.S. Application Data
(62) Division of application No. 16/489,371, filed on Aug. 28, 2019.

(30) Foreign Application Priority Data
Mar. 2, 2017 (JP) 2017-039845
Mar. 28, 2017 (JP) 2017-063694
Mar. 30, 2017 (JP) 2017-069238

(51) Int. Cl. B23K 9/173; B23K 35/30

(52) U.S. Cl. CPC B23K 9/173; B23K 35/30

(57) ABSTRACT

Disclosed herein is an arc welding method including arc welding a steel sheet by a pulse control method, wherein: welding is performed using a welding wire and a gas containing Ar at a voltage pulse frequency of 50 Hz or more and 200 Hz or less and a voltage pulse width of 1.5 ms or more and 10 ms or less; and the welding wire contains C and further contains, in mass %: Si: 0.2% or more and 1.1% or less; Mn: 0.2% or more and 1.4% or less; and S: 0.010% or more and 0.050% or less, with the balance being Fe and inevitable impurities.

### TECHNICAL FIELD

The present invention relates to an arc welding method.

### BACKGROUND ART

As arc welding methods capable of reducing generation of sputtering during welding of a thin steel sheet, an arc welding method in which welding is performed while controlling the feeding of the wire in a moving direction or an arc welding method by a pulse control method are known.

For example, Patent Literature 1 discloses, as an arc welding method for preventing generation of porosity such as blowholes and generation of sputtering, a welding method of performing arc welding by repeating short circuits and arcs for a member having been subjected to a surface treatment by using a wire. The welding method includes a step of transferring a droplet formed from the wire to the member side and a step of welding a member such that the gas generated from the member is discharged from the generation position by pushing the molten pool in a direction opposite to a welding advancing direction. Then, by the backward feeding of the wire, the distance between the wire and the molten pool is set to a predetermined range, and a predetermined welding current for generating an arc force for pushing the molten pool is supplied, and the welding current is kept constant or gradually increased or decreased for a predetetinined period.

For example, Patent Literature 2 discloses, as a welding method which is less likely to generate sputtering during welding and is excellent in weldability, a gas shielded arc welding method that uses a welding wire having a predetermined chemical composition, and uses a mixed gas of an inert gas and a carbon dioxide gas as a shielding gas to perform pulsed MAG welding by a pulsed arc method. Here, in the gas shielded arc welding method described in Patent Literature 1, the pulse frequency is preferably controlled to 60 Hz to 120 Hz from the viewpoints of prevention of sputtering generation and prevention of welding defects. From the viewpoints of prevention of sputtering generation and penetration stability, the pulse width is preferably controlled to 1.0 msec to 1.3 msec.

### CITATION LIST

### Patent Literature

Patent Literature 1: Japanese Patent No. 6043969
Patent Literature 2: Japanese Patent No. 3523917

### SUMMARY OF INVENTION

### Technical Problem

A steel sheet used for an automobile, a building material, an electric machine, or the like may be subjected to an electrodeposition coating step after arc welding. In such a case, when the slag does not sufficiently agglomerate in the welded portion during arc welding, slag remains in the welded portion. When the slag remains in the welded portion, there is a problem that the adhesion of the coat formed by the subsequent electrodeposition coating cannot be sufficiently ensured. Therefore, in such an application, it is required that the slag agglomeration property during welding is good.

However, in the arc welding method disclosed in Patent Literature 1 and Patent Literature 2, the slag agglomeration property has not been sufficiently studied, and there is room for improvement. That is, when the slag is not sufficiently agglomerated during welding, the slag remains in the welded portion, and as a result, the above-described problem may occur. In particular, in the welding of a thin steel sheet, a travel speed is also required to be high, and the slag agglomeration property is also required to be good while increasing the travel speed.

The present invention has been made in view of the above circumstances, and an object of the present invention is to provide an arc welding method which can reduce generation of sputtering and also improve slag agglomeration property while increasing the travel speed.

### Solution to Problem

A first embodiment of the present invention relates to an arc welding method including welding a steel sheet while controlling feeding of a welding wire in a moving direction,

in which welding is performed using the welding wire and a gas containing Ar at a frequency of 35 Hz or more and 160 Hz or less in the moving direction of the welding wire,

the welding wire containing C and further containing, in mass %:

Si: 0.2% or more and 1.3% or less;

Mn: 0.2% or more and 1.5% or less; and

5: 0.01% or more and 0.05% or less,

with the balance being Fe and inevitable impurities.

In a preferred aspect of the first embodiment of the present invention, the welding wire may further contain, in mass %, at least one of: Al: 0.1% or more and 0.5% or less; Mo: 0.1% or more and 2.0% or less; Ti: 0.3% or less; and Cu: 0.4% or less.

In a preferred aspect of the first embodiment of the present invention, the contents of S and Al in the welding wire may satisfy the following relationship: 0.3≤S×10+Al≤0.7.

In a preferred aspect of the first embodiment of the present invention, the steel sheet may have a thickness of 0.6 mm or more and 5 mm or less.

In a preferred aspect of the first embodiment of the present invention, the welding may be performed at a frequency of 45 Hz or more and 130 Hz or less, more preferably 70 Hz or more and 110 Hz or less, in the moving direction of the welding wire.

In a preferred aspect of the first embodiment of the present invention, the welding may be performed at a welding current of 80 A or more and 350 A or less as an average value thereof and a travel speed of 60 cm/min or more.

A second embodiment of the present invention relates to an arc welding method including arc welding a steel sheet by a pulse control method,

in which welding is performed using a welding wire and a gas containing Ar at a voltage pulse frequency of 50 Hz or more and 200 Hz or less and a voltage pulse width of 1.5 ms or more and 10 ms or less,

the welding wire containing C and further containing, in mass %:

Si: 0.2% or more and 1.1% or less;

Mn: 0.2% or more and 1.4% or less; and

S: 0.010% A or more and 0.050% or less,

with the balance being Fe and inevitable impurities.

In a preferred aspect of the second embodiment of the present invention, the welding wire may further contain, in mass %, at least one of: Al: 0.1% or more and 0.5% or less; Mo: 0.1% or more and 2.0% or less; and Cu: 0.4% or less.

In a preferred aspect of the second embodiment of the present invention, the welding may be performed at a peak current of 380 A or more and 490 A or less.

In a preferred aspect of the second embodiment of the present invention, the welding may be performed at a base current of 80 A or more and 180 A or less.

In a preferred aspect of the second embodiment of the present invention, the welding may be performed with a Duty ratio of a pulse current of 0.2 or more and 0.6 or less.

In a preferred aspect of the second embodiment of the present invention, the steel sheet may have a thickness of 0.6 mm or more and 5 mm or less.

### Advantageous Effects of Invention

According to the arc welding method of the present invention, the generation of sputtering can be reduced, and the slag agglomeration property is also improved while the travel speed is increased.

### DESCRIPTION OF EMBODIMENTS

Hereinafter, embodiments for carrying out the present invention are described in detail. The present invention is not limited to the embodiments described below.

### First Embodiment

In an arc welding method according to a first embodiment of the present invention (hereinafter, also referred to as a welding method according to the first embodiment), the arc welding method includes welding a steel sheet while controlling feeding of a welding wire in a moving direction, and welding is performed using the welding wire and a gas containing Ar at a frequency of 35 Hz or more and 160 Hz or less in the moving direction of the welding wire, the welding wire containing C and further containing, in mass %: Si: 0.2% or more and 1.3% or less; Mn: 0.2% or more and 1.5% or less; and S: 0.01% or more and 0.05% or less, the balance being Fe and inevitable impurities.

In the welding method according to the first embodiment, the arc welding is performed while controlling the feeding of the wire in the moving direction. More specifically, the following procedures are repeated: the wire is advanced (forward fed) accompanying with generating an arc while the feeding of the wire is controlled in the moving direction, the wire is retreated (backward fed) after the molten metal of the melted wire tip is brought into contact with the molten pool to extinguish the arc, and the molten metal is transferred. By performing the welding in this manner, generation of sputtering during welding can be reduced. The frequency in the moving direction of the wire in the welding method according to the first embodiment is as follows: one advancing (forward feeding) and retreating (backward feeding) of the wire is defined as one cycle. Examples of the welding method according to the first embodiment include, for example, cold metal transfer welding and the like.

### <Welding Wire>

Next, the reason why the content of each element of a welding wire used in the welding method according to the first embodiment (hereinafter, referred to as the wire according to the first embodiment, also simply referred to as a wire) is limited is described below. The content of each element is a content with respect to the total mass of the wire. Further, in the present description, the percentage based on the mass (mass %) is synonymous with the percentage based on the weight (wt %).

### (C)

C is an element for improving the strength. In the wire according to the first embodiment, C should be contained, that is, the content of C should be more than 0%, but in order to more favorably achieve the above effect, the content of C is preferably 0.02 mass % or more, and more preferably 0.04 mass % or more.

The upper limit of the content of C is not particularly limited, but the content of C is preferably 0.15 mass % or less, and more preferably 0.10 mass % or less, from the viewpoint of the reduction of sputtering and preventing hot cracking.

### (Si)

Si is an effective deoxidizer and is an essential element for deoxidation of the weld metal. When the content of Si is less than 0.2 mass %, the deoxidizing effect is impaired, the surface tension decreases, and porosity such as pits or blowholes is likely to occur. In addition, slag agglomeration property decreases. Therefore, the content of Si is 0.2 mass % or more, preferably 0.3 mass % or more, and more preferably 0.5 mass % or more.

On the other hand, the lower the content of Si is, the lower the electric resistance of the wire is, and the lower the electric resistance of the wire is, the harder the wire melts (the lower the electrical resistance heat is), so that the required welding current is increased, and as a result, porosity such as pits and blow holes can be prevented by the increase of the arc force. When the content of Si is more than 1.3 mass %, the amount of slag generated on the surface of the bead increases, and slag agglomeration property also decreases. Therefore, the content of Si is 1.3 mass % or less, preferably 1.2 mass % or less, and more preferably 1.0 mass % or less.

### (Mn)

Mn is an effective deoxidizer similar to Si, and is an element that is likely to be bonded to S. When the content of Mn is less than 0.2 mass %, the deoxidization effect and desulfurization effect are impaired, surface tension decreases, and porosity such as pits and blowholes is likely to occur. In addition, slag agglomeration property decreases. Therefore, the content of Mn is 0.2 mass % or more, preferably 0.3 mass % or more, and more preferably 0.5 mass % or more.

On the other hand, when the content of Mn is more than 1.5 mass %, a thin oxide film that is unlikely to be peeled off is generated on the surface of the bead. In addition, slag agglomeration property decreases. Therefore, the content of Mn is 1.5 mass % or less, preferably 1.3 mass % or less, and more preferably 1.1 mass % or less.

### (S)

S is an element contributing to agglomeration of slag, but the effect is not obtained when the content thereof is less than 0.01 mass %, so that the content of S is 0.01 mass % or more, and preferably 0.02 mass % or more.

On the other hand, when the content of S is more than 0.05 mass %, the flow of the surface of the molten pool greatly changes, and the slag is moved close to the vicinity of the arc immediately below the arc, so that the agglomeration effect is reduced. Therefore, the content of S is preferably 0.05 mass % or less, and preferably 0.04 mass % or less.

The balance of the wire according to the first embodiment is Fe and inevitable impurities, and examples of the inevitable impurities include P, Cr, Ni, N, O, and the like, and the inevitable impurities are allowed to be included in a range that does not impair the effects of the present invention.

In addition to the above-described chemical components, at least one of the following components may be further added to the wire according to the first embodiment.

### (Al)

Al is an element contributing to agglomeration of slag. In the wire according to the first embodiment, the addition of Al is not essential, but the slag aggregation effect is unlikely to be obtained when the content of Al is less than 0.1 mass %, and thus, when Al is added, the content of Al is preferably 0.1 mass % or more, and more preferably 0.2 mass % or more.

On the other hand, when the content of Al is more than 0.5 mass %, the droplet separation may be unstable, the vibration of the molten pool may be disturbed, sputtering may occur frequently, and the slag agglomeration effect may be reduced. Therefore, when Al is added, the content thereof is preferably 0.5 mass % or less, and more preferably 0.4 mass % or less.

### (Mo)

Mo is an element contributing to the improvement of the strength. In the wire according to the first embodiment, the addition of Mo is not essential, but in order to achieve such an effect well, when Mo is added, the content of Mo is preferably 0.1 mass % or more, and more preferably 0.3 mass % or more.

On the other hand, when the content of Mo is more than 2.0 mass %, the effect is saturated since Mo forms an intermetallic compound with Fe at a high temperature. Therefore, when Mo is added, the content thereof is preferably 2.0 mass % or less, and more preferably 1.5 mass % or less.

### (Ti)

Ti is a strong deoxidizing element and is effective when the amount of oxygen in the wire is high since the amount of oxygen in the molten metal can be reduced and the surface tension can be reduced. However, when more than 0.3 mass % of Ti is added, a large amount of slag is generated. Therefore, when Ti is added, the content thereof is preferably 0.3 mass % or less, and more preferably 0.2 mass % or less.

### (Cu)

Cu is an element effective in improving electrical conductivity and rust resistance. In the case of containing Cu, the lower limit of the content thereof is not particularly limited, but the content of Cu is preferably 0.1 mass % or more in order to obtain such an effect better. From the viewpoint of preventing the occurrence of hot cracking, the content of Cu is preferably 0.4 mass % or less. The wire of the first embodiment may be subjected to Cu plating as desired. Here, the content of Cu means a total of the content of Cu contained in the base metal of the wire and the content of Cu plating.

(0.3≤S×10+Al≤0.7)

In the wire according to the first embodiment, the contents of S and Al preferably satisfy the following relationship. In this case, by adjusting the contents of S and Al so as to satisfy such a relationship, the slag agglomeration property can be improved.

0.3≤S×10+Al≤0.7

### (Diameter of Wire)

In the first embodiment, the diameter of the wire is not particularly limited, and may be appropriately selected from commonly applied range. The diameter of the wire is, for example, 0.8 mm to 1.4 mm. The same applies to the second embodiment to be described later.

### (Method for Manufacturing Wire)

As a method for manufacturing the wire, for example, a wire of a steel material having a predetermined composition may be drawn to a predetermined diameter. The wire drawing may be either a method using a hole die or a method using a roller die. When Cu plating is performed, wire drawing may be performed after the Cu plating. The same applies to the second embodiment to be described later.

### <Shielding Gas>

The shielding gas used in the welding method according to the first embodiment only needs to contain Ar, and may consist of Ar. Alternatively, in addition to Ar, CO₂, O₂, or the like may be contained, and for example, a shielding gas having approximately 5 vol. % to 30 vol. % of CO, or O₂ and the balance being Ar may be used. It should be noted that N₂, H₂, or the like as inevitable impurities may also be contained in the shielding gas.

Here, it is desirable that the content proportion of Ar in the shielding gas is preferably higher since the amount of slag decreases as the content proportion of Ar in the shielding gas increases. From this viewpoint, the content proportion of Ar is preferably 70 vol. % or more, and more preferably 80 vol. % or more. On the other hand, as described above, the shielding gas may consist of Ar (that is, the content ratio of Ar may be 100 vol. %), but the content of Ar may be, for example, 70 vol. % or less. The same applies to the second embodiment to be described later.

### <Frequency in Moving Direction of Wire>

In the welding method according to the first embodiment, when the feeding of the wire in the moving direction of the wire is controlled, the frequency in the advancing and retracting direction of the wire is controlled to be 35 Hz or more and 160 Hz or less.

As a result of intensive studies, the present inventors have found that the natural frequency of the molten metal is about several tens of Hz and by controlling the frequency in the moving direction of the wire to an appropriate range to match the natural frequency of the molten pool, the vibration of the surface of the molten pool is optimum, and the flow of the molten metal of the surface of the molten pool changes so as to involve the slag, and the slag agglomeration property can be improved. When the frequency in the moving direction of the wire is less than 35 Hz, short circuits occur frequently in the peak current period, regular droplet transfer cannot be performed, vibration of the molten pool is disturbed, and good slag agglomeration property cannot be obtained, so that the frequency in the moving direction of the wire is set to 35 Hz or more, preferably 45 Hz or more, and more preferably 70 Hz or more. On the other hand, when the frequency in the moving direction of the wire is more than 160 Hz, the effect of depressing the molten pool due to the arc in the peak period is reduced, sufficient amplitude of the molten pool cannot be obtained, and good slag agglomeration property cannot be obtained, so that the frequency in the moving direction of the wire is set to 160 Hz or less, preferably 150 Hz or less, more preferably 130 Hz or less, and even more preferably 110 Hz or less.

### <Base Metal>

The base metal to be welded in the welding method according to the first embodiment should be a steel sheet, and the composition, thickness, or the like of the steel sheet are not particularly limited, and the welding method is applicable to, for example, a thin steel sheet having a thickness of 0.6 mm or more and 5.0 mm or less. The kind of the steel may be, for example, mild steel or high-tensile steel up to 590 MPa grade. Various plating treatments such as zinc plating and aluminum plating may be applied to the surface of the base metal. The same applies to the second embodiment to be described later.

### <Welding Conditions>

In the welding method according to the first embodiment, the welding conditions such as the welding current, the arc voltage, the travel speed, the welding position, or the like are not particularly limited, and may be appropriately adjusted within a range that can be applied in arc welding methods.

Here, the average value of the welding current is, for example, 80 A or more and 350 A or less, and preferably 100 A or more and 300 A or less. The travel speed is, for example, 60 cm/min or more. According to the welding method according to the first embodiment, welding can be performed with good slag agglomeration property even under these welding conditions.

### Second Embodiment

In an arc welding method according to a second embodiment of the present invention (hereinafter, also referred to as a welding method according to a second embodiment), the arc welding method includes arc welding a steel sheet by a pulse control method, and welding is performed using a welding wire and a gas containing Ar at a voltage pulse frequency of 50 Hz or more and 200 Hz or less and a voltage pulse width of 1.5 ins or more and 10 ms or less, the welding wire containing C and further containing, in mass %, Si: 0.2% or more and 1.1% or less, Mn: 0.2% or more and 1.4% or less, S: 0.010% or more and 0.050% or less, with the balance being Fe and inevitable impurities.

### <Welding Wire>

The content of each element of the welding wire used in the welding method according to the second embodiment and the appropriate range thereof are as follows.

The reason for numerical limitation is the same as in the first embodiment.

### (C)

In terms of the lower limit, the content of C is more than 0%, preferably 0.02 mass % or more, and more preferably 0.04 mass % or more.

In terms of the upper limit, the content of C is preferably 0.15 mass % or less, and more preferably 0.10 mass % or less.

### (Si)

In terms of the lower limit, the content of Si is 0.2 mass % or more, preferably 0.3 mass % or more, and more preferably 0.5 mass % or more.

In terms of the upper limit, the content of Si is 1.1 mass % or less, preferably 1.0 mass % or less, and more preferably 0.9 mass % or less.

### (Mn)

In terms of the lower limit, the content of Mn is 0.2 mass % or more, preferably 0.3 mass % or more, and more preferably 0.5 mass % or more.

In terms of the upper limit, the content of Mn is 1.4 mass % or less, preferably 1.3 mass % or less, and more preferably 1.1 mass % or less.

### (S)

In terms of the lower limit, the content of S is 0.010 mass % or more, and preferably 0.020 mass % or more.

In terms of the upper limit, the content of S is 0.050 mass % or less, and preferably 0.040 mass % or less.

The balance of the wire according to the second embodiment is Fe and inevitable impurities, and examples of the inevitable impurities include Ti, P, Cr, Ni, N, O, and the like, and the inevitable impurities are allowed to be included in a range that does not impair the effects of the present invention.

In addition to the above-described chemical components, at least one of Al, Mo, and Cu may be further added to the wire according to the second embodiment, and the appropriate range of the additive amount and the reason thereof are the same as those in the first embodiment.

### <Pulse Parameters>

Next, pulse parameters in the welding method according to the second embodiment are described.

(Voltage Pulse Frequency: 50 Hz or more and 200 Hz or less)
(Voltage Pulse Width: 1.5 ms or more and 10 ms or less)

In the welding method according to the second embodiment, when arc welding is performed by the pulse control method, the pulse is controlled such that a voltage pulse frequency (hereinafter, also simply referred to as a pulse frequency) is 50 Hz or more and 200 Hz or less, and a voltage pulse width (hereinafter also simply referred to as a pulse width) is 1.5 ms or more and 10 ms or less.

As a result of intensive studies, the present inventors have found that the natural frequency of the molten metal is about several tens of Hz and by controlling pulse frequency and pulse width to an appropriate range to match the natural frequency of the droplet, the vibration of the molten pool is optimum, and the flow of the molten metal of the surface of the molten pool changes so as to involve the slag, and the slag agglomeration property can be improved.

When the pulse frequency is more than 200 Hz and/or the pulse width is less than 1.5 ms, the effect of depressing the molten pool due to the arc in the peak period is reduced, and the sufficient amplitude of the molten pool cannot be obtained, and the good slag agglomeration property is unlikely to be obtained. Therefore, the pulse frequency is 200 Hz or less, and the pulse width is 1.5 ms or more. The pulse frequency is preferably 180 Hz or less, and more preferably 150 Hz or less. The pulse width is preferably 3 ms or more, and more preferably 5 ms or more.

On the other hand, when the pulse frequency is less than 50 Hz and/or the pulse width is more than 10 ms, since the peak period is long, the formed droplet is too large, the droplet transfer is unstable, so that the vibration of the molten pool is disturbed and the good slag agglomeration property is unlikely to be obtained. Furthermore, sputtering is likely to occur, and the appearance of the bead deteriorates. Therefore, the pulse frequency is set to 50 Hz or more, and the pulse width is 10 ms or less. The pulse frequency is preferably 55 Hz or more, and more preferably 60 Hz or more. The pulse width is preferably 9 ms or less, and more preferably 8 ms or less.

In the welding method according to the second embodiment, it is preferable to control the pulse current during welding as follows.

### (Peak Current: 380 A or More and 490 A or Less)

During the peak current period, a droplet is formed, and at the same time, the molten pool is depressed by an arc force. Here, in the welding method according to the second embodiment, the peak current is not particularly limited, but is preferably 380 A or more and 490 A or less from the following viewpoints. That is, when the peak current is less than 380 A, the arc force sufficient to depress the molten pool may not be obtained. Therefore, the peak current is preferably 380 A or more, more preferably 400 A or more, and further more preferably 410 A or more.

On the other hand, when the peak current is more than 490 A, the formed droplet is too large and is irregularly short-circuited with the molten pool, and the molten pool cannot be regularly vibrated. In addition, the arc force is excessive, and the flow of convection that depresses the slag backward with respect to the welding advancing direction may be too strong. As a result, agglomeration of slag may be inhibited. Therefore, the peak current is preferably 490 A or less, more preferably 480 A or less, and further more preferably 460 A or less.

### (Base Current: 80 A or More and 180 A or Less)

In the base current period, by lowering the arc force, the droplet formed by the peak current is likely to be separated. Here, in the welding method according to the second embodiment, the base current is not particularly limited, but is preferably 80 A or more and 180 A or less from the following viewpoints. That is, when the base current is less than 80 A, the range of the execution current may be greatly restricted. Therefore, the base current is preferably 80 A or more, more preferably 90 A or more, and further more preferably 100 A or more.

On the other hand, when the base current is more than 180 A, the amount of heat input is excessive, which is likely to cause burn-through when a thin steel sheet is welded. Therefore, the base current is preferably 180 A or less, more preferably 160 A or less, and further more preferably 150 A or less.

### (Duty Ratio: 0.2 to 0.6)

In the welding method according to the second embodiment, the Duty ratio of the pulse current is not particularly limited, but is preferably 0.2 to 0.6 from the following viewpoint. That is, when the Duty ratio is less than 0.2, the peak current period is too short as compared to the base current period, the effect of depressing the molten pool by the arc cannot be sufficiently obtained, and the melting pool cannot be sufficiently vibrated, so that the slag agglomeration effect may decrease. Therefore, the Duty ratio of the pulse current is preferably 0.2 or more, and more preferably 0.3 or more.

On the other hand, when the Duty ratio is more than 0.6, a short circuit frequently occurs in the peak current period, sputtering occurs frequently, and the vibration of the molten pool is likely to be irregular, so that the slag agglomeration effect may be reduced. Therefore, the Duty ratio of the pulse current is preferably 0.6 or less, more preferably 0.5 or less.

In the welding method according to the second embodiment, the average current of the pulse current is not particularly limited, and may be appropriately determined depending on an appropriate range of the peak current, the base current, and the Duty ratio described above. The average current of the pulse current is, for example, 250 A or more and 350 A or less.

### <Welding Conditions>

In the welding method according to the second embodiment, the welding conditions such as the travel speed, the welding position, or the like are not particularly limited, and may be appropriately adjusted within a range that can be applied in arc welding methods.

The travel speed is, for example, 70 cm/min or more. According to the welding method according to the second embodiment, even when the travel speed is increased, welding can be performed with good slag agglomeration property.

### EXAMPLES

Hereinafter, the present invention is described in more detail with reference to Examples, but the present invention is not limited to these Examples, and can be carried out by adding changes within the scope of the present invention, and all of which are included in the technical scope of the present invention.

In the following, the first embodiment is described by way of Examples and Comparative Examples.

Using a wire with a diameter of 1.2 mm having the compositions shown in Tables 1 and 2, welding was performed under the following conditions while controlling feeding frequency in the moving direction of the wire to the frequencies shown in Tables 1 and 2.

### (1) Steel Sheet

A steel sheet with 200 mm length×60 mm width×3.2 mm thickness was used. The kind of the steel of the steel sheet is SPHC 590.

### (2) Welding Position

A lap joint welding was performed.

### (3) Shielding Gas

In Cases 1 to 28 and Cases 30 to 59 in Table 1, Ar+20 vol. % CO₂ was used as the shielding gas.

In Case 29 in Table 1 and Case 60 in Table 2, 100 vol. % CO₂ was used as the shielding gas.

### (4) Welding Current and Arc Voltage

Welding was performed at a welding current of 240 A and an arc voltage of 18 V.

### (5) Travel Speed and Welding Length

The travel speed was 100 cm/min. Welding was performed to achieve a welding length of 150 mm.

In Tables 1 and 2 and Table 3 described later, the “wire component (mass %)” means the amount (mass %) of each component per total mass of the wire. The expression “−” means that the content is less than the detection limit. The content of Cu shown in Tables 2 and 3 includes a content of Cu plating. The balance is Fe and inevitable impurities.

### (Evaluation of Slag Agglomeration Property)

The slag on the surface of the bead was visually observed at a welding length of 150 mm, and the slag on the surface was collected and evaluated based on the following criteria. In addition, “∘∘” and “∘” are passed, and “x” is not passed.

∘∘: 90 wt % or more of the slag based on the total amount of slag existed (was agglomerated) in the vicinity of the crater section.

∘: 50 wt % or more and less than 90 wt % of the slag based on the total amount of slag existed (was agglomerated) in the vicinity of the crater section.

x: Less than 50 wt % of the slag based on the total amount of slag existed (was agglomerated) in the vicinity of the crater portion.

TABLE 1

| | | | | | | | | | | | Evaluation of Slag |
|---|---|---|---|---|---|---|---|---|---|---|---|
| | Wire Component (mass %) | | | | | | | | Frequency | | Agglomeration |
| No. | C | Si | Mn | S | Al | Mo | Ti | Shielding Gas | (Hz) | 10 × S + Al | Property |
| 1 | 0.05 | 1.0 | 1.2 | 0.03 | 0.2 | — | — | Ar + 20% CO₂ | 55 | 0.5 | ∘∘ |
| 2 | 0.05 | 0.3 | 0.8 | 0.02 | 0.1 | — | — | Ar + 20% CO₂ | 55 | 0.3 | ∘ |
| 3 | 0.05 | 0.5 | 1.3 | 0.02 | 0.2 | 0.1 | — | Ar + 20% CO₂ | 55 | 0.4 | ∘ |
| 4 | 0.05 | 0.8 | 0.3 | 0.02 | 0.3 | 0.1 | — | Ar + 20% CO₂ | 55 | 0.5 | ∘ |
| 5 | 0.08 | 0.8 | 1.2 | 0.05 | 0.1 | 0.1 | — | Ar + 20% CO₂ | 55 | 0.6 | ∘ |
| 6 | 0.05 | 0.8 | 0.8 | 0.01 | 0.2 | 0.1 | — | Ar + 20% CO₂ | 55 | 0.3 | ∘ |
| 7 | 0.05 | 0.5 | 0.8 | 0.02 | 0.5 | 0.1 | — | Ar + 20% CO₂ | 55 | 0.7 | ∘ |
| 8 | 0.07 | 0.8 | 0.8 | 0.03 | 0.1 | 1.8 | — | Ar + 20% CO₂ | 70 | 0.4 | ∘ |
| 9 | 0.10 | 0.8 | 0.8 | 0.03 | 0.2 | 0.5 | — | Ar + 20% CO₂ | 70 | 0.5 | ∘ |
| 10 | 0.10 | 0.8 | 0.8 | 0.03 | 0.1 | 0.1 | — | Ar + 20% CO₂ | 70 | 0.4 | ∘ |
| 11 | 0.10 | 0.5 | 0.5 | 0.03 | 0.3 | 0.1 | 0.3 | Ar + 20% CO₂ | 70 | 0.6 | ∘ |
| 12 | 0.10 | 0.5 | 1.2 | 0.05 | 0.2 | 0.2 | — | Ar + 20% CO₂ | 70 | 0.7 | ∘ |
| 13 | 0.08 | 0.8 | 1.2 | 0.05 | 0.1 | 0.1 | — | Ar + 20% CO₂ | 150 | 0.6 | ∘ |
| 14 | 0.08 | 0.8 | 1.2 | 0.05 | 0.1 | 0.1 | — | Ar + 20% CO₂ | 90 | 0.6 | ∘∘ |
| 15 | 0.08 | 0.8 | 1.2 | 0.05 | 0.1 | 0.1 | — | Ar + 20% CO₂ | 40 | 0.6 | ∘ |
| 16 | 0.08 | 0.8 | 1.2 | 0.05 | 0.1 | 0.1 | — | Ar + 20% CO₂ | 70 | 0.6 | ∘∘ |
| 17 | 0.08 | 0.9 | 1.2 | 0.02 | — | — | 0.2 | Ar + 20% CO₂ | 70 | | ∘ |
| 18 | 0.04 | 0.8 | 1.0 | 0.02 | — | 0.1 | — | Ar + 20% CO₂ | 70 | | ∘ |
| 19 | 0.05 | 0.5 | 1.0 | 0.03 | — | 0.3 | — | Ar + 20% CO₂ | 55 | | ∘ |
| 20 | 0.05 | 0.5 | 1.0 | 0.03 | — | 0.3 | — | Ar + 20% CO₂ | 90 | | ∘ |
| 21 | 0.08 | 1.0 | 1.3 | 0.005 | 0.1 | 0.1 | — | Ar + 20% CO₂ | 55 | 0.15 | x |
| 22 | 0.08 | 0.8 | 1.2 | 0.06 | 0.2 | 0.2 | — | Ar + 20% CO₂ | 55 | 0.8 | x |
| 23 | 0.08 | 0.8 | 1.2 | 0.05 | 0.1 | 0.1 | — | Ar + 20% CO₂ | 180 | 0.6 | x |
| 24 | 0.08 | 0.8 | 1.2 | 0.05 | 0.1 | 0.1 | — | Ar + 20% CO₂ | 30 | 0.6 | x |
| 25 | 0.08 | 0.1 | 1.2 | 0.01 | 0.1 | 0.1 | — | Ar + 20% CO₂ | 75 | 0.2 | x |
| 26 | 0.08 | 1.5 | 1.2 | 0.01 | 0.1 | 0.1 | — | Ar + 20% CO₂ | 75 | 0.9 | x |
| 27 | 0.08 | 0.8 | 0.1 | 0.01 | 0.1 | 0.1 | — | Ar + 20% CO₂ | 75 | 0.2 | x |
| 28 | 0.08 | 0.8 | 1.6 | 0.01 | 0.1 | 0.1 | — | Ar + 20% CO₂ | 75 | 0.2 | x |
| 29 | 0.05 | 0.8 | 0.8 | 0.01 | 0.2 | 0.1 | — | 100% CO₂ | 55 | 0.3 | x |

TABLE 2

| | | | | | | | | | | | | Evaluation of Slag |
|---|---|---|---|---|---|---|---|---|---|---|---|---|
| | Wire Component (mass %) | | | | | | | | | Frequency | | Agglomeration |
| No. | C | Si | Mn | S | Al | Mo | Cu | Ti | Shielding Gas | (Hz) | 10 × S + Al | Property |
| 30 | 0.05 | 1.0 | 1.2 | 0.03 | 0.2 | — | 0.3 | — | Ar + 20% CO₂ | 55 | 0.5 | ∘∘ |
| 31 | 0.03 | 0.3 | 0.7 | 0.02 | 0.1 | — | 0.3 | — | Ar + 20% CO₂ | 55 | 0.3 | ∘ |
| 32 | 0.04 | 0.4 | 1.3 | 0.02 | 0.2 | 0.1 | 0.2 | — | Ar + 20% CO₂ | 55 | 0.4 | ∘ |
| 33 | 0.05 | 0.7 | 0.3 | 0.02 | 0.3 | 0.2 | 0.2 | — | Ar + 20% CO₂ | 55 | 0.5 | ∘ |
| 34 | 0.07 | 0.8 | 1.1 | 0.05 | 0.1 | 0.1 | 0.2 | — | Ar + 20% CO₂ | 55 | 0.6 | ∘ |
| 35 | 0.05 | 0.8 | 0.8 | 0.01 | 0.2 | 0.1 | 0.2 | — | Ar + 20% CO₂ | 55 | 0.3 | ∘ |
| 36 | 0.05 | 0.5 | 0.8 | 0.03 | 0.5 | 0.1 | 0.2 | — | Ar + 20% CO₂ | 55 | 0.8 | ∘ |
| 37 | 0.07 | 0.8 | 0.8 | 0.03 | 0.1 | 2.0 | 0.2 | — | Ar + 20% CO₂ | 70 | 0.4 | ∘ |
| 38 | 0.09 | 0.8 | 0.8 | 0.03 | 0.2 | 0.5 | 0.2 | — | Ar + 20% CO₂ | 70 | 0.5 | ∘ |
| 39 | 0.10 | 0.8 | 0.8 | 0.03 | 0.1 | 0.1 | 0.2 | — | Ar + 20% CO₂ | 70 | 0.4 | ∘ |
| 40 | 0.10 | 0.5 | 0.5 | 0.03 | 0.3 | 0.1 | 0.2 | 0.3 | Ar + 20% CO₂ | 70 | 0.6 | ∘ |
| 41 | 0.10 | 0.5 | 1.1 | 0.05 | 0.2 | 0.2 | 0.2 | — | Ar + 20% CO₂ | 70 | 0.7 | ∘ |
| 42 | 0.08 | 0.8 | 1.1 | 0.05 | 0.1 | 0.1 | 0.2 | — | Ar + 20% CO₂ | 150 | 0.6 | ∘ |
| 43 | 0.08 | 0.8 | 1.2 | 0.05 | 0.1 | 0.1 | 0.2 | — | Ar + 20% CO₂ | 90 | 0.6 | ∘∘ |
| 44 | 0.09 | 0.8 | 1.2 | 0.05 | 0.1 | 0.1 | 0.2 | — | Ar + 20% CO₂ | 40 | 0.6 | ∘ |
| 45 | 0.08 | 0.7 | 1.2 | 0.05 | 0.1 | 0.1 | 0.2 | — | Ar + 20% CO₂ | 70 | 0.6 | ∘∘ |
| 46 | 0.08 | 0.6 | 1.1 | 0.02 | — | — | 0.1 | 0.2 | Ar + 20% CO₂ | 70 | | ∘ |
| 47 | 0.05 | 0.8 | 1.1 | 0.02 | — | — | 0.1 | 0.2 | Ar + 5% CO₂ | 70 | | ∘ |
| 48 | 0.05 | 0.6 | 1.1 | 0.02 | — | — | 0.1 | 0.2 | Ar + 30% CO₂ | 70 | | ∘ |
| 49 | 0.04 | 0.8 | 0.8 | 0.02 | — | 0.1 | 0.1 | — | Ar + 20% CO₂ | 70 | | ∘ |
| 50 | 0.05 | 0.5 | 1.0 | 0.03 | — | 0.3 | 0.1 | — | Ar + 20% CO₂ | 55 | | ∘ |
| 51 | 0.05 | 0.5 | 1.0 | 0.02 | — | 0.3 | 0.1 | — | Ar + 20% CO₂ | 90 | | ∘ |
| 52 | 0.07 | 1.0 | 1.3 | 0.005 | 0.1 | 0.1 | 0.3 | — | Ar + 20% CO₂ | 55 | 0.15 | x |
| 53 | 0.07 | 0.8 | 1.2 | 0.06 | 0.2 | 0.2 | 0.3 | — | Ar + 20% CO₂ | 55 | 0.8 | x |
| 54 | 0.08 | 0.8 | 1.2 | 0.04 | 0.1 | 0.1 | 0.3 | — | Ar + 20% CO₂ | 180 | 0.5 | x |
| 55 | 0.08 | 0.8 | 1.1 | 0.05 | 0.1 | 0.1 | 0.2 | — | Ar + 20% CO₂ | 30 | 0.6 | x |
| 56 | 0.08 | 0.1 | 1.2 | 0.01 | 0.1 | 0.1 | 0.2 | — | Ar + 20% CO₂ | 75 | 0.2 | x |
| 57 | 0.07 | 1.5 | 1.2 | 0.01 | 0.1 | 0.1 | 0.3 | — | Ar + 20% CO₂ | 75 | 0.2 | x |
| 58 | 0.08 | 0.8 | 0.1 | 0.01 | 0.1 | 0.1 | 0.1 | — | Ar + 20% CO₂ | 75 | 0.2 | x |
| 59 | 0.08 | 0.8 | 1.6 | 0.01 | 0.1 | 0.1 | 0.1 | — | Ar + 20% CO₂ | 75 | 0.2 | x |
| 60 | 0.05 | 0.8 | 0.9 | 0.01 | 0.2 | 0.1 | 0.2 | — | 1.00% CO₂ | 55 | 0.3 | x |

Among Cases 1 to 60, Cases 1 to 20 and Cases 30 to 51 are Examples, and Cases 21 to 29 and Cases 52 to 60 are Comparative Examples. As shown in Tables 1 and 2, good slag agglomeration property was obtained in Cases 1 to 20 and Cases 30 to 51.

Since the content of S in the wire was too small in Cases 21 and 52, and the content of S in the wire was too large in Cases 22 and 53, the slag agglomeration property was deteriorated.

Since the frequency of the wire in the moving direction was too large in Cases 23 and 54, and the frequency of the wire in the moving direction was too small in Cases 24 and 55, the slag agglomeration property was deteriorated.

Since the content of Si in the wire was too small in Cases 25 and 56, and the content of Si in the wire was too large in Cases 26 and 57, the slag agglomeration property was deteriorated.

Since the content of Mn content in the wire was too small in Cases 27 and 58, and the content of Mn in the wire was too large in Cases 28 and 59, the slag agglomeration property was deteriorated.

In Cases 29 and 60, since 100% CO₂ gas containing no Ar was used as the shielding gas, the slag agglomeration property was deteriorated.

Next, the second embodiment is described with reference to Examples and Comparative Examples.

Using a wire with a diameter of 1.2 mm having the composition shown in Table 3, arc welding was performed with pulse control under the following conditions.

### (1) Steel Sheet

A steel sheet with 200 mm length×60 mm width×3.2 mm thickness was used. The kind of the steel of the steel sheet is SPHC 590.

### (2) Welding Position

A lap joint welding was performed.

### (3) Shielding Gas

In Cases 61 to 90 and 92 to 93 in Table 3, Ar+20 vol. % CO₂ was used as the shielding gas.

In Case 91 of Table 3, 100 vol. % CO₂ was used as the shielding gas.

### (4) Pulse Parameters

The welding was performed while controlling the pulse frequency (Hz), the pulse width (ins), the peak current (A), the base current (A), and the Duty ratio under the conditions shown in Table 3.

### (5) Travel Speed and Welding Length

The travel speed was 100 cm/min. Welding was performed to achieve a welding length of 150 mm.

### (Evaluation of Slag Agglomeration Property)

The slag on the surface of the bead was visually observed at a welding length of 150 mm, the slag on the surface was collected, and the proportion (wt %) of slag existing (agglomerated) in the vicinity of the crater portion based on the total amount of slag was determined and described in the column of “slag agglomeration proportion (wt %)” in Table 3. Here, when the proportion of slag existing (agglomerated) in the vicinity of the crater portion is 60 wt % or more, it can be evaluated that the slag agglomeration property is good. In the case where the proportion of slag existing (agglomerated) in the vicinity of the crater portion is less than 60 wt % and the slag agglomeration property is poor, the result is indicated as “x” in the “slag agglomeration proportion (wt %)” in Table 3, and the description of the proportion is omitted.

### (Evaluation of Bead Appearance)

The appearance of the weld bead obtained in each case was evaluated by the following criteria.

∘∘: smooth bead appearance with few unevenness of the surface

∘: good bead appearance without undercut, or the like

x: Irregularities in the bead and unevenness or the like of the surface are generated, and the bead appearance is poor

TABLE 3

| | | | | | | | | | Pulse Parameters | | | | | Slag | |
|---|---|---|---|---|---|---|---|---|---|---|---|---|---|---|---|
| | | | | | | | | | Pulse | Pulse | Peak | Base | | Agglomeration | |
| | Wire Component (mass %) | | | | | | | | Frequency | Width | Current | Current | Duty | Proportion | Bead |
| No. | C | Si | Mn | S | Cu | Al | Mo | Shielding Gas | (Hz) | (ms) | (A) | (A) | Ratio | (wt %) | Appearance |
| 61 | 0.04 | 1.1 | 0.8 | 0.012 | 0.1 | — | — | Ar + 20% CO₂ | 80 | 7 | 460 | 130 | 0.5 | 65 | ∘∘ |
| 62 | 0.04 | 0.2 | 0.8 | 0.020 | 0.1 | — | — | Ar + 20% CO₂ | 80 | 7 | 460 | 130 | 0.5 | 61 | ∘ |
| 63 | 0.05 | 0.8 | 1.4 | 0.018 | 0.2 | — | — | Ar + 20% CO₂ | 110 | 5.5 | 460 | 130 | 0.5 | 82 | ∘∘ |
| 64 | 0.08 | 0.8 | 0.2 | 0.020 | 0.2 | — | — | Ar + 20% CO₂ | 110 | 5.5 | 460 | 130 | 0.5 | 72 | ∘∘ |
| 65 | 0.07 | 0.8 | 1.0 | 0.045 | 0.2 | — | — | Ar + 20% CO₂ | 120 | 5.5 | 470 | 135 | 0.5 | 77 | ∘∘ |
| 66 | 0.07 | 0.5 | 0.9 | 0.010 | 0.2 | — | — | Ar + 20% CO₂ | 80 | 4 | 460 | 130 | 0.5 | 78 | ∘ |
| 67 | 0.04 | 0.5 | 0.8 | 0.030 | 0.2 | 0.5 | — | Ar + 20% CO₂ | 190 | 3 | 450 | 135 | 0.5 | 90 | ∘ |
| 68 | 0.03 | 0.5 | 0.8 | 0.035 | 0.3 | 0.1 | — | Ar + 20% CO₂ | 190 | 3 | 450 | 135 | 0.5 | 92 | ∘ |
| 69 | 0.03 | 0.5 | 0.8 | 0.030 | 0.3 | 0.1 | 0.5 | Ar + 20% CO₂ | 190 | 3 | 450 | 135 | 0.5 | 91 | ∘ |
| 70 | 0.02 | 0.5 | 0.8 | 0.030 | 0.3 | 0.1 | 1.8 | Ar + 20% CO₂ | 190 | 3 | 450 | 135 | 0.5 | 93 | ∘ |
| 71 | 0.05 | 0.4 | 0.5 | 0.050 | 0.3 | 0.3 | 0.3 | Ar + 20% CO₂ | 200 | 3 | 480 | 110 | 0.6 | 87 | ∘ |
| 72 | 0.03 | 0.8 | 1.2 | 0.020 | 0.2 | — | — | Ar + 20% CO₂ | 130 | 7 | 490 | 110 | 0.5 | 95 | ∘∘ |
| 73 | 0.03 | 0.8 | 1.1 | 0.020 | 0.2 | — | — | Ar +20% CO₂ | 50 | 9 | 440 | 140 | 0.5 | 63 | ∘∘ |
| 74 | 0.03 | 0.8 | 1.1 | 0.015 | 0.2 | — | — | Ar + 20% CO₂ | 80 | 6 | 450 | 130 | 0.4 | 93 | ∘∘ |
| 75 | 0.10 | 0.3 | 0.8 | 0.025 | 0.2 | 0.3 | 0.1 | Ar + 20% CO₂ | 55 | 10 | 480 | 110 | 0.6 | 68 | ∘ |
| 76 | 0.04 | 0.8 | 0.8 | 0.010 | 0.2 | — | — | Ar + 20% CO₂ | 190 | 1.5 | 480 | 120 | 0.2 | 91 | ∘∘ |
| 77 | 0.05 | 0.7 | 1.1 | 0.010 | 0.1 | — | — | Ar + 20% CO₂ | 130 | 7 | 490 | 110 | 0.5 | 90 | ∘∘ |
| 78 | 0.05 | 0.8 | 1.1 | 0.010 | 0.1 | — | — | Ar + 20% CO₂ | 135 | 3 | 380 | 110 | 0.5 | 84 | ∘∘ |
| 79 | 0.05 | 0.8 | 1.1 | 0.010 | — | — | — | Ar + 20% CO₂ | 111 | 3 | 380 | 110 | 0.3 | 96 | ∘∘ |
| 80 | 0.05 | 0.8 | 1.1 | 0.010 | — | — | — | Ar + 20% CO₂ | 111 | 3 | 380 | 110 | 0.3 | 91 | ∘∘ |
| 81 | 0.07 | 0.6 | 1.1 | 0.015 | 0.2 | — | — | Ar + 20% CO₂ | 111 | 3 | 380 | 110 | 0.3 | 87 | ∘∘ |
| 82 | 0.05 | 0.8 | 1.0 | 0.010 | 0.2 | — | — | Ar + 20% CO₂ | 100 | 6 | 450 | 100 | 0.6 | 93 | ∘∘ |
| 83 | 0.05 | 0.8 | 1.1 | 0.007 | 0.2 | 0.1 | 0.1 | Ar + 20% CO₂ | 130 | 7 | 490 | 110 | 0.5 | x | ∘ |
| 84 | 0.05 | 0.8 | 1.1 | 0.065 | 0.2 | — | — | Ar + 20% CO₂ | 130 | 7 | 490 | 110 | 0.5 | x | ∘ |
| 85 | 0.04 | 0.5 | 0.5 | 0.050 | 0.2 | 0.3 | 0.3 | Ar + 20% CO₂ | 250 | 2 | 490 | 80 | 0.5 | x | ∘∘ |
| 86 | 0.05 | 0.5 | 0.5 | 0.050 | 0.3 | 0.3 | 0.3 | Ar + 20% CO₂ | 45 | 9 | 460 | 110 | 0.4 | x | x |
| 87 | 0.05 | 0.1 | 0.6 | 0.020 | 0.3 | 0.1 | 0.1 | Ar + 20% CO₂ | 190 | 3 | 450 | 135 | 0.5 | x | x |
| 88 | 0.05 | 1.2 | 1.2 | 0.020 | 0.2 | 0.3 | 0.1 | Ar +20% CO₂ | 190 | 3 | 450 | 135 | 0.5 | x | ∘ |
| 89 | 0.03 | 0.8 | 0.1 | 0.012 | 0.2 | 0.1 | — | Ar + 20% CO₂ | 110 | 5.5 | 460 | 130 | 0.5 | x | ∘ |
| 90 | 0.05 | 0.5 | 1.5 | 0.050 | 0.1 | 0.1 | 0.5 | Ar + 20% CO₂ | 110 | 5.5 | 460 | 130 | 0.5 | x | ∘ |
| 91 | 0.04 | 1.0 | 0.8 | 0.015 | 0.1 | — | — | 100% CO₂ | 80 | 7 | 460 | 130 | 0.5 | x | ∘ |
| 92 | 0.05 | 0.5 | 1.4 | 0.050 | 0.1 | 0.1 | 0.5 | Ar + 20% CO₂ | 190 | 1.3 | 490 | 130 | 0.25 | x | ∘∘ |
| 93 | 0.05 | 0.5 | 1.5 | 0.045 | 0.2 | 0.1 | 0.5 | Ar + 20% CO₂ | 55 | 11 | 490 | 80 | 0.6 | x | x |

Among Cases 61 to 93 and Cases 61 to 82 are Examples, and Cases 83 to 93 are Comparative Examples. As shown in Table 3, good slag agglomeration property was obtained in Cases 61 to 82. In addition, the bead appearance was also good.

Since the content of S in the wire was too small in Case 83, and the content of S in the wire was too large in Case 84, the slag agglomeration property was deteriorated.

In Case 85, since the pulse frequency was too large, the slag agglomeration property was deteriorated. In Case 86, since the pulse frequency was too small, the slag agglomeration property was deteriorated and the bead appearance was also poor.

In Case 87, since the content of Si in the wire was too small, the slag agglomeration property was deteriorated and the bead appearance was also poor. In Case 88, since the content of Si in the wire was too large, the slag agglomeration property was deteriorated.

Since the content of Mn in the wire was too small in Case 89, and the content of Mn in the wire was too large in Case 90, the slag agglomeration property was deteriorated.

In Case 91, since 100% CO₂ gas containing no Ar was used as the shielding gas, the slag agglomeration property was deteriorated.

In Case 92, since the pulse width was too small, the slag agglomeration property was deteriorated. In Case 93, since the pulse width was too large and the content of Mn in the wire was too large, the slag agglomeration property was deteriorated and the bead appearance was also poor.

Although the present invention is described in detail with reference to specific embodiments, it will be apparent to those skilled in the art that various changes and modifications can be made without departing from the spirit and scope of the present invention. This application is based on Japanese Patent Application No. 2017-039845 filed on Mar. 2, 2017, Japanese Patent Application No. 2017-063694 filed on Mar. 28, 2017, and Japanese Patent Application No. 2017-069238 filed on Mar. 30, 2017, the entireties of which are incorporated by reference. In addition, all references cited herein are incorporated in their entirety.

1-7. (canceled)

8. An arc welding method, comprising arc welding a steel sheet by a pulse control method, wherein:
welding is performed using a welding wire and a gas containing Ar at a voltage pulse frequency of 50 Hz or more and 200 Hz or less and a voltage pulse width of 1.5 ms or more and 10 ms or less; and
the welding wire contains C and further contains, in mass %:
Si: 0.2% or more and 1.1% or less:
Mn: 0.2% or more and 1.4% or less; and
S: 0.010% or more and 0.050% A or less,
with the balance being Fe and inevitable impurities.

9. The arc welding method according to claim 8, wherein the welding wire further contains, in mass %, at least one of:
Al: 0.1% or more and 0.5% or less;
Mo: 0.1% or more and 2.0% or less; and
Cu: 0.4% or less.

10. The arc welding method according to claim 8, wherein the welding is performed at a peak current of 380 A or more and 490 A or less.

11. The arc welding method according to claim 8, wherein the welding is performed at a base current of 80 A or more and 180 A or less.

12. The arc welding method according to claim 8, wherein the welding is performed with a Duty ratio of a pulse current of 0.2 or more and 0.6 or less.

13. The arc welding method according to claim 8, wherein the steel sheet has a thickness of 0.6 mm or more and 5 mm or less.
